(19) United States
(12) Patent Application Publication
(10) Pub. No.: US 2007/0029246 A1
(43) Pub. Date: Feb. 8, 2007

(54) Adsorbent carbon, water quality purifier, water quality purifying bag, water quality purifying substrate and method of removing oil film

(76) Inventor: Tosiya Ueda, Sakai-Shi (JP)

Correspondence Address: JORDAN AND HAMBURG LLP, 122 EAST 42ND STREET, SUITE 4000, NEW YORK, NY, 10168, US

(21) Appl. No.: 11/366,932

(22) Filed: Mar. 1, 2006

(30) Foreign Application Priority Data
Jul. 20, 2005 (JP) 2005-210000

(51) Int. Cl. B01D 15/02

(52) U.S. Cl. 210/263

(57) ABSTRACT

The present invention provides a novel adsorbent carbon, water quality purifier, water quality purifying bag and water quality purifying substrate which are floated on the water for a long time when sprayed, and as a result, are in contact with oil (oil film) contained in, particularly, natural waters such as rivers, lakes and the sea, waste water such as effluents from factories, sewage, basins of rain water and are present in a floated state on the water, to thereby remove the oil (oil film) in an efficient manner, and a method of removing an oil film. The adsorbent carbon is formed by using a coconut mesocarp as its raw material and by carrying out heating and carbonizing treatment of the mesocarp.

### BACKGROUND OF THE INVENTION

1. Field of the Invention

The invention relates to an adsorbent carbon, water quality purifier, water quality purifying bag and water quality purifying substrate which are used to remove oil (oil film) contained in, particularly, natural waters such as rivers, lakes and the sea, waste water such as effluents from factories, sewage, basins of rain water and are present in a floated state on the water in an efficient manner, and a method of removing an oil film.

2. Description of the Related Art

Oils spilled by mistake in service stations, airfields and military bases which handle fuels such as gasoline, light oil, kerosene, and jet fuel, waste water, such as effluents from factories, which contains organic solvents and is generated in various factories are resultantly mingled in basins of rain water, sewage and waste water even if considerable care is taken, form a thin oil film and are spilled out in the condition that it is diffused and floated on the water. Then, these oils are flowed into natural waters such as rivers, rakes and the sea, giving rise to the problem that the natural environment is impaired.

For this, means taken to remove an oil film on the water have been researched and developed (for example, Japanese Patent Application Laid-Open No. 8-182929, No. 6-85035, No. 6-170359, No. 2004-131855 and No. 2002-346380)

The means for removing an oil film as described in these Patent Publications use a mat or sheet that absorbs oil. However, it takes time for the mats or sheets to adsorb oil, and also it is necessary to lay a considerable number of mats and sheets for removing an oil film spread widely on the water, posing the problem that this requires high cost, labor and troublesome works.

In the meantime, activated carbon is the most simple and has a high efficiency and is therefore frequently used as a material which can adsorb and remove impurities in water.

Activated carbon has one improved ability to adsorb gases and dyes by subjecting a raw material (activated carbon raw material) including wood, sawdust, carbonized wood, charcoal, coconut husk or lignin to heating and carbonizing treatment. From the reason that the activated carbon has the relatively high ability to adsorb odor components such as living odor components and adsorbates such as VOC gas such as formalin, ethylbenzene or xylene, which is a cause of Schickhouse syndrome, and is inexpensive, it is most widely used in the fields of purification of water, deodorants used in refrigerators and shoe cupboards, and deodorizing and adsorbing products for filters of air cleaners.

Additionally, because the activated carbon just after heating and carbonizing treatment has a relatively low specific gravity, it can be floated on the water. Therefore, if such activated carbon is sprayed on the water, on which oil film appears, in an amount corresponding to the oil, the oil is adsorbed and it is therefore possible to purify water quality.

### SUMMARY OF THE INVENTION

However, such activated carbon has the adsorbing characteristics that adsorption of water takes preference adsorption of oil. Therefore, when activated carbon is sprayed on the water, it absorbs water in a short time, with the result that activated carbon is increased in specific gravity so that it is sunk in the water. Therefore, oil-adsorbing efficiency is very low and it is also necessary to carry out an operation for recovering activated carbon sunk with oil adsorbed thereto under the water, giving rise to troublesome works.

In view of this situation, the present inventors have made earnest studies to solve the above problems, and, as a result, developed adsorbent carbon by using a coconut mesocarp as a raw material and by carrying out heating to carbonize the mesocarp.

Specifically, the inventors have taken notice of the point that when the mesocarp (raw material) of a coconut is observed on an electron microscope, independent pores are integrated among them or in combination with continuous pores to form a complicated network structure, thereby forming a honeycomb structure in which a large number of existing pores are adjacent to each other, to obtain such findings that when a coconut mesocarp is heated and carbonized, it is made into adsorbent carbon which has a honeycomb structure in which a large number of existing pores are adjacent to each other and therefore made into a carbonized material (adsorbent carbon) having a lower specific gravity than that of conventional activated carbon using, as its raw material, wood, sawdust, carbonized wood, charcoal, coconut husk or lignin and that when the above adsorbent carbon produced using a coconut mesocarp as the raw material is sprayed on the water, it continues floating on the water even if it absorbs water a little and it is therefore possible to make it into contact with an oil film on the water over a long time.

The inventors have also obtained such findings that as mentioned above, the adsorbent carbon obtained using a coconut mesocarp as its raw material has a complicated honeycomb structure in which independent pores are integrated among them or in combination with continuous pores and it is therefore superior in the ability of adsorbing all types of oil.

In the meantime, conventionally, a coconut mesocarp except for its fiber components has no utility value and is not almost used but dumped as wastes at present, leading to such findings that it is possible to procure the raw material at a very low cost and a coconut mesocarp also has a large advantage from the viewpoint of the utilization of wastes.

The present invention has been completed based on the foregoing findings, and it is an object of the present invention to provide a novel adsorbent carbon, water quality purifier, water quality purifying bag, and water quality purifying substrate which are floated on the water for a long time when sprayed on the water, with the result that these materials are in contact with oil (oil film) contained in, particularly, natural waters such as rivers, lakes and the sea, waste water such as effluents from factories, sewage, basins of rain water and therefore can remove the oil (oil film) efficiently; and also to provide a method of removing an oil film.

In order to attain the above object an adsorbent carbon according to the present invention uses a coconut mesocarp as its raw material, and heating to carbonize the mesocarp is carried out.

### BRIEF DESCRIPTION OF THE DRAWINGS

FIG. 1 is a schematic view showing a step wherein a mixture of an adsorbent carbon and ethylene-vinyl acetate copolymer is poured into a mold having a specified shape in a producing step of water quality purifier of Example 2;

FIG. 2 is a schematic view showing a state wherein the mixture of the adsorbent carbon and ethylene-vinyl acetate copolymer is filled in a mold having a specific shape in the producing step of water quality purifier of Example 2;

FIG. 3 is a schematic view showing a state wherein steam is passing through filler in the mold in the producing step of water quality purifier of Example 2;

FIG. 4 is a schematic view view showing a steam-passing apparatus preferably used in the producing step of water quality purifier of Example 2;

FIG. 5 is a schematic view showing step wherein a mixture of an adsorbent carbon and ethylene-vinyl acetate copolymer is laminated between a substrate and a cover material in a producing step of a water quality purifying substrate of Example 3;

FIG. 6 is a schematic view showing a state wherein steam is passing through the laminate in the producing step of the water quality purifying substrate of Example 3;

FIG. 7 is a schematic view showing a step wherein a mixture of an adsorbent carbon and foam beads is poured into a mold having a specified shape in a producing step of a water quality purifying substrate of Example 4; and

FIG. 8 is a perspective view showing the water quality purifying substrate of Example 4.

### DETAILED DESCRIPTION OF THE INVENTION

Here, a coconut has a three-layer structure constituted of a “albumen” located in its centermost part, an “endcarp (coconut husk)” that envelopes the outside of the albumen and a “mesocarp” surrounding so as to envelope the endcarp. Generally, the albumen is supplied mainly for food and the coconut endcarp (coconut husk) is supplied for raw material of coconut husk activated carbon or the like.

On the other hand, the mesocarp except for its fiber component is not almost utilized but dumped as wastes at present.

However, the inventors have made earnest studies as to the utilization of the coconut mesocarp to find that a coconut mesocarp has a complicated structure in which independent pores are integrated among them or in combination with continuous pores, and therefore, when a coconut mesocarp is heated to carbonize, adsorbent carbon having a complicated honeycomb structure is obtained and this adsorbent carbon is a carbonized material (adsorbent carbon) having a lower specific gravity than that of conventional activated carbon using, as its raw material, wood, sawdust, carbonized wood, charcoal, coconut husk or lignin.

Then, when the adsorbent carbon produced using the coconut mesocarp as its raw material is sprayed on the water, it continues floating on the water even if it absorbs a little water and can keep in touch with oil (oil film) on the water for a long time. As a result, this adsorbent carbon can efficiently adsorb and remove the aforementioned oil (oil film).

Also, as mentioned above, the adsorbent carbon obtained using a coconut mesocarp as its raw material has a complicated honeycomb structure in which independent pores are integrated among them or in combination with continuous pores, and therefore has a structure in which pores have different sizes ranging widely showing that it is superior in adhesion to all types of oil.

Also, as mentioned above, a coconut mesocarp except for its fiber component has almost no utility value and is not almost utilized but is dumped as wastes at present, and therefore it is possible to procure the raw material at a very low cost and a coconut mesocarp also has a large advantage from the viewpoint of the utilization of wastes.

The adsorbent carbon of the present invention will be herein below explained in more detail.

The adsorbent carbon of the present invention use a coconut mesocarp as its raw material, which is heated to carbonize.

In the meantime, a coconut mesocarp contains a fiber component. In the case of the adsorbent carbon of the present invention, a mesocarp put in the state where it contains a fiber component may be subjected to heating to carbonize as it is. However, if a large amount of fiber component is contained in the adsorbent carbon, the specific gravity of the adsorbent carbon is increased as a whole. Therefore in the present invention, it is preferable to use a coconut mesocarp from which a fiber component has been further removed as the raw material.

In the present invention, a term “subjected to heating to carbonize” means the treatment in which heat is applied to the raw material (coconut mesocarp) to carbonize. The treating temperature in this heating for carbonization is preferably in a range from 350 to 850° C. in the present invention though no particular limitation is imposed on it insofar as it is a temperature enough to carbonize the raw material. When this heating temperature for carbonization is less than 350° C., only unsatisfactory carbonization is attained, leading to poor adhesion to oil (oil film), whereas when the temperature exceeds 850° C., there is a fear that the aforementioned honeycomb structure is broken and this is also undesirable also from the viewpoint of energy saving.

Also, in the present invention, the raw material (coconut mesocarp) may be subjected to an activating treatment at the same time when heated to carbonize or after heated to carbonize with the intention of improving adsorbing ability.

This activating treatment is similar to a treatment performed for improving an adsorbing ability when producing usual activated carbon and is largely classified into two types, namely, a “gas activating method” and a “chemical activating method”.

The former gas activating method is a general method used frequently in the industrial production of activated carbon. In the case of the gas activating method used in the present invention, the aforementioned adsorbent carbon is further treated particularly at a temperature of about 650 to 850° C. in a steam or carbon dioxide atmosphere.

On the other hand, the latter chemical activating method used in the present invention is a method in which the aforementioned activated carbon is impregnated with a processing solution such as an aqueous zinc chloride solution and carbonization and activation are carried out particularly at a temperature of about 350 to 700° C. at the same time.

Specifically, in the present invention, no particular limitation is placed upon which activating method to use. However, it has been clarified that the adhesion of the adsorbent carbon to oil is increased by setting the temperature of activating treatment to a temperature slightly lower than usually used temperature. Therefore, in the present invention, the activating treatment is preferably carried out at about 350 to 850° C. and more preferably about 400 to 850° C. which is relatively lower than usual temperature.

The reason why the adsorbing ability is raised when the adsorbent carbon is treated at a relatively lower temperature is considered to be that when the adsorbent carbon is treated at a relatively lower temperature, the honeycomb structure of the aforementioned raw material (coconut mesocarp) remains as it is whereas when the adsorbent carbon is treated at a high temperature, there is a fear that the aforementioned honeycomb structure is broken.

Although the adsorbent carbon of the present invention may be used in the form of a powder as it is, it may be usually made into a desired form for example a pellet form such as a granular form, plate form and disk form, tablet form or pill form upon use.

Here, when the adsorbent carbon of the present invention is processed into a desired form, a means for sticking and securing the adsorbent carbon through a binder may be used. However, particularly in the present invention, it is preferable to use a means for processing the adsorbent carbon into a desired form by filling the adsorbent carbon and a hot melt type resin having a powder or granular form in a mold having an intended form and by making steam pass from one side to other side of the filled material to melt the above hotmelt type resin by the heat of the steam, thereby developing adhesiveness.

This reason is that if, for example, a means for sticking the adsorbent carbon through a binder is simply used, it takes a relatively long time to dry a binder, and almost all part of the adsorbent carbon is embedded in the binder, so that there is therefore the case where the adsorbing characteristics of the adsorbent carbon are impaired. As to this point, when the above means is used in which the adsorbent carbon and a hot melt type resin form are filled in a mold having an intended shape and steam is made to pass from one side to other side of the filled material to melt the above hotmelt type resin by the heat of the steam, thereby developing adhesiveness to form the adsorbent carbon into a desired shape and to fix the adsorbent carbon, the adsorbent carbon can be molded into a desired shape in a short time and fixed and also, the embedding of the adsorbent carbon can be limited to the lowest minimum, with the result that the activity of the adsorbent carbon can be maintained.

Any hotmelt resins may be used as the hotmelt type resin to be used in the present invention without any particular limitation insofar as it develops adhesiveness when treated by the heat of steam. As the hotmelt type resin, at least one type selected from polyolefin type resins such as polyethylene and polypropylene, ethylene-vinyl acetate copolymers, polystyrenes, polyisobutylenes, polyamide resins and polyester resins may be given as examples. Among these resins, polyethylene and ethylene-vinyl acetate copolymers are melted at relatively low temperature to develop adhesiveness and are also inexpensive and are therefore desirable.

The water quality purifier of the present invention comprises the aforementioned adsorbent carbon of the present invention as its major component. When this water quality purifier is sprayed on natural waters such as rivers, lakes and the sea, waste water such as effluents from factories, sewage and basins of rain water, it is floated on the water for a long time, with the result that oil (oil film) floated on the water is in contact with the water quality purifier continuously for a long time and it is therefore possible to remove the oil (oil film) efficiently.

Here, the term “as its major component” means the case where the water quality purifier is formed only of the adsorbent carbon and also means that the purifier may contain other functional materials to the extent that the oil-adsorbing ability of the adsorbent carbon is not impaired, when the adsorbent carbon is used as the water quality purifier. Examples of the other functional material may include adsorbents such as usual activated carbon and zeolite that are used in general, fiber products such as cotton fabrics used to improve oil-absorbing ability and foaming agents. In this case, generally, the proportion of the adsorbent carbon is preferably about 60% by weight or more based on the whole water quality purifier. Then, particularly, it is the most desirable to manufacture the water quality purifier by using only the adsorbent carbon.

The water quality purifying bag of the present invention is characterized by sealing the aforementioned adsorbent carbon of the present invention into a bag material and is improved in handling characteristics of the adsorbent carbon such as conveying characteristics, portability and recovery characteristics.

Any bag material may be used as the above bag material without any particular limitation insofar as it has liquid permeability and prevents easy leakage of the sealed adsorbent carbon. Examples of the bag material may include those obtained by making nonwoven fabrics, sheets, textiles, woven fabrics, paper products, liquid-permeable polymer films or sheets which are obtained by boring treatment, into bags.

On the contrary, the water quality purifying substrate is characterized by making a support member support the aforementioned adsorbent carbon of the present invention and this is also improved in handling characteristics of the adsorbent carbon such as conveying characteristics, portability and recovery characteristics.

Here, examples of a method of supporting the adsorbent carbon on a support member may include means for first mixing the adsorbent carbon with a binder and applying the mixture to an optionally selected support member to thereby make the support member support the adsorbent carbon on the surface thereof.

The means for sticking the adsorbent carbon to the support member through a binder is advantageous in the point that the adsorbent carbon can be supported easily on the support member regardless of the material, shape and qualities of the support member. However, if this means is used, it takes relatively long time to dry the binder and also, almost all part of the adsorbent carbon is embedded in the binder, so that there is therefore the case where the adsorbing characteristics of the adsorbent carbon are impaired.

For this, in the case of the water quality purifying substrate of the present invention, means illustrated in the following are preferably taken when the adsorbent carbon is supported by the support member.

First, as one of preferable methods for supporting the adsorbent carbon on the support member while limiting a deterioration in the adsorbing characteristics of the adsorbent carbon to the lowest minimum may include means using a fiber product as the support member to support the adsorbent carbon in a fiber net of the fiber product.

Specifically, if, using the fiber product, the adsorbent carbon is supported in a fiber net of the fiber product without using a sticking means such as a binder when the adsorbent is supported by the support member in the water quality substrate of the present invention, the supported adsorbent carbon can always maintain an active condition.

Any fiber products may be used as the above fiber product without any particular limitation in so far as the adsorbent carbon can be supported in a net made of the fiber product. Examples of the fiber product may include cloth substrates such as clothes, towel clothes, blankets, kilts, knits, nonwoven fabrics and sheets made of natural fibers and/or artificial fibers and paper and pulp molds made of pulp fibers.

However, there is the case where the means for supporting the adsorbent carbon in a fiber net of the fiber product gives rise to the problem that the adsorbent carbon leaks or falls down and the amount of the adsorbent carbon to be supported is decreased.

As to this point, examples of one of other preferable methods of supporting the adsorbent carbon by the support member in the water quality purifying substrate may include a method in which a film-like or sheet-like substrate or cover material which has liquid permeability is selected as the support member, the adsorbent carbon is laminated on the above substrate and the adsorbent carbon is covered with the above cover material to thereby stick the substrate to the cover material partly, thereby supporting the adsorbent carbon between the substrate and the cover material.

Also, when the adsorbent carbon is supported by the support member, a method may be exemplified in which the adsorbent carbon and a powder or granular hotmelt type resin are laminated on a substrate which has liquid permeability and has a film-like or sheet-like form and the resulting layer is covered with the above cover material to form a laminate. Then, steam is made to pass through the laminate in the direction of the thickness of the laminate to thereby melt the above hotmelt type resin by the heat of the steam to allow the resin to develop adhesiveness, thereby supporting the adsorbent carbon between the substrate and the cover material. Such a structure makes it possible to prevent the adsorbent from leaking and falling down and to appropriately control the amount of the adsorbent carbon to be sandwiched.

Also, in this method, steam is made to pass through the laminate in the direction of the thickness of the laminate to thereby melt the above hotmelt type resin with the heat of the steam to allow the resin to develop adhesiveness, thereby supporting the adsorbent carbon between the substrate and the cover material, whereby the adsorbent carbon can be secured in a short time without impairing permeability and flexibility and also, the embedding of the adsorbent carbon in the resin can be limited to the lowest minimum, with the result that the activity of the adsorbent carbon can be maintained.

Examples of the above substrate and cover material include cloth bodies made of natural fibers and/or artificial fibers. Specific examples of the cloth body made of natural fibers and/or artificial fibers may usually include clothes, towel clothes, blankets, kilts, knits, paper, nonwoven fabrics and sheets.

Examples of one of other preferable methods of supporting the adsorbent carbon by the support member in the water quality purifying substrate of the present invention may include a method in which a foam plastic is used as a support material to support the adsorbent carbon in the foam plastic.

Here, the term “foam plastic” means those molded as products ranging from a low-foam product expanded about 1.1 to 10 times to a high-foam product expanded over 100 times, by using polystyrene, polyurethane, ABS resins, polyvinyl chloride, polyethylene, polypropylene, phenol resins, urea resins, epoxy resins and silicon resins as a base polymer and by conducting the following foaming means, for example, “(1) addition of a volatile or decomposable foaming agent, (2) blowing of air or nitrogen, (3) making foams by spraying or (4) utilization of a reaction product gas”. As a result, a network of a number of pores is formed in the foam plastic.

Specifically, when the adsorbent carbon is supported on the support member, a foam plastic is used as the support member to support the adsorbent carbon in the foam plastic with the result that the adsorbent carbon is kept in a network of a number of pores and therefore the embedding of the adsorbent carbon can be limited to the lowest minimum and the activity of the adsorbent carbon can be therefore maintained.

Here, although no particular limitation is imposed on a means of supporting the adsorbent carbon in the foam plastic, specific examples include a means of mixing foaming beads prepared by penetrating pentane or freon into plastic beads made of the aforementioned base polymer with the adsorbent carbon and filling the mixture in a specified mold, followed by heating to thereby foam.

As mentioned above, the water quality purifying substrate of the present invention has the advantage that the handling characteristics of the adsorbent carbon such as conveying characteristics, portability and recovery characteristics are improved. If the adsorbent carbon is supported by the support member, there is the case where the adsorbent carbon is prevented from distributing widely on the water when used.

In the case where it is required for the water quality purifying substrate to diffuse widely on the water, water-soluble or water-decomposable materials, such as tissues and toilet paper, which are easily dissolved and broken when brought into contact with water, are preferably used as the support member in the water quality purifying substrate of the present invention to thereby disperse the supported adsorbent carbon.

The method of removing oil according to the present invention comprises using the aforementioned adsorbent carbon, water quality purifier, water quality purifying bag or water quality purifying substrate of the present invention to remove an oil film floated on the water. When this water quality purifier is sprayed on natural waters such as rivers, lakes and the sea, waste water such as effluents from factories, sewage and basins of rain water, oil (oil film) floated on the water can be removed efficiently.

The present invention relates to an adsorbent carbon that has the aforementioned structure to efficiently remove oil (oil film) that is contained in natural waters such as rivers, lakes and the sea, waste water such as effluents from factories, sewage and basins of rain water and is present in a floated state on the water.

Specifically, the adsorbent carbon of the present invention is obtained by using, as its raw material, the mesocarp of a coconut having a honeycomb structure in which independent pores are integrated among them or in combination with continuous pores to form a complicated network structure and a large number of pores present are adjacent to each other and by heating to carbonize the mesocarp. This adsorbent carbon is a carbonized material having a smaller specific gravity than that of conventional activated carbon. Therefore, if the water quality purifier of the present invention is sprayed on the water, it continues floating on the water even if it absorbs a little water and can be in contact with oil (oil film) on the water for a long time, producing, for example, the effect of removing the oil (oil film) efficiently.

Also, as mentioned above, the adsorbent carbon obtained using the mesocarp of a coconut has a complicated honeycomb structure in which independent pores are integrated among them or in combination with continuous pores and which has pores having different sizes ranging very widely and therefore produces, for example, such an effect that it is superior in adhesion to all types of oil.

Also, a coconut mesocarp except for its fiber component has almost no utility value and is not almost utilized but is dumped as wastes at present, and therefore, it is possible to procure the raw material at a very low cost stably and a coconut mesocarp also has a large advantage from the viewpoint of the utilization of wastes.

Then, the water quality purifier of the present invention comprises the aforementioned adsorbent carbon of the present invention as its major component. When this water quality purifier is sprayed on natural waters such as rivers, lakes and the sea, waste water such as effluents from factories, sewage and basins of rain water, it is floated on the water for a long time, with the result that oil (oil film) floated on the water is in contact with the water quality purifier continuously for a long time, producing the effect of removing the oil (oil film) efficiently.

Also, the water quality purifying bag of the present invention is characterized by sealing the adsorbent carbon of the present invention in a bag material, producing, for example, the effect of significantly improving the handling characteristics of the adsorbent carbon such as conveying characteristics, portability and recovery characteristics.

Moreover, the water quality purifying substrate of the present invention is characterized by supporting the adsorbent carbon of the present invention on a support member, producing, for example, the effect of improving the handling characteristics of the adsorbent carbon such as conveying characteristics, portability and recovery characteristics.

The method of removing oil according to the present invention comprises using the aforementioned water quality purifier, water quality purifying bag or water quality purifying substrate to remove an oil film floated on the water. When the water quality purifier, water quality purifying bag and water quality purifying substrate of the present invention are sprayed on natural waters such as rivers, lakes and the sea, waste water such as effluents from factories, sewage and basins of rain water, they are floated on the water for a long time, with the result that they are in contact with the oil (oil film) in a floated state for a long time, producing, for example, the effect of removing oil (oil film) floated on the water efficiently.

Preferred embodiments of the present invention will be explained in detail. However, the present invention is not limited to the following Examples.

### EXAMPLE 1

A coconut mesocarp was washed in a water stream to remove a fiber component to some extent. The resulting coconut mesocarp was dried and heated at about 550° C. The coconut mesocarp in a red-heated condition was heated at about 600° C. in a mixed gas atmosphere containing steam, carbon dioxide gas (CO₂ in a combustion gas) and oxygen (O₂ in the combustion air) to carry out carbonization, thereby obtaining an adsorbent carbon powder according to the present invention.

### COMPARATIVE EXAMPLE 1

A coconut husk (coconut endcarp) was dried to remove a micropowder to obtain an activated carbon raw material, which was treated at 800° C. and the resulting activated carbon raw material in a red-heated condition was heated at about 900° C. in a mixed gas atmosphere containing steam, carbon dioxide gas (CO₂ in a combustion gas) and oxygen (O₂ in the combustion air) to carry out activating treatment thereby obtaining an activated carbon powder.

<Comparative Test>

Three angular stainless pallets having a length of 20 cm, a width of 15 cm and a height of 15 cm were prepared and 3000 ml of city water was poured into each of these pallets. Light oil 1.5 ml was dripped on the water in the angular stainless pallet by using a burette to disperse this light oil. Then, 15 g of the adsorbent carbon powder obtained in Example 1 was sprayed and dispersed on the water in each pallet, which was then allowed to stand for night and day.

Also, in the same manner as above, three angular stainless pallets having a length of 20 cm, a width of 15 cm and a height of 15 cm were prepared and 3000 ml of city water was poured into each of these pallets. Light oil 1.5 ml was dripped on the water in the angular stainless pallet by using a burette to disperse this light oil. Then, 15 g of the activated carbon powder obtained in Comparative Example 1 was sprayed and dispersed on the water in each burette, which was then allowed to stand for night and day.

Moreover, for Reference Example, one angular stainless pallet which was the same one as that used in Example 1 and Comparative Example 1 was prepared and 3000 ml of city water was poured into the pallet in the same manner as in Example 1 and Comparative Example 1. Light oil 1.5 ml was dripped on the water in the angular stainless pallet by using a burette to disperse this light oil, which was then allowed to stand for night and day as it was.

Specifically, in this Reference Example, any oil adsorbent was not sprayed.

When the state of each angular stainless pallet was confirmed after each sample was allowed to stand day and night, the adsorbent carbon powder was still floated on the water in all of the three samples of Example 1 in which the adsorbent carbon powder was sprayed, whereas almost all the activated carbon powder sunk under the water in all of the three samples of Comparative Example 1 in which the activated carbon powder was sprayed, and it was also confirmed that light oil film remained on the water.

Also, as to the samples of Example 1 and Comparative 1, the adsorbent carbon and the activated carbon were taken out from each angular stainless pallet, to visually confirm the state of a light oil film in the angular stainless pallet.

As a result, in the sample of Example 1 in which the adsorbent carbon powder was sprayed, a light oil film disappeared and it was confirmed that any oil (light oil) could not be observed.

On the other hand, in the sample of Comparative Example in which the activated carbon was sprayed, it was confirmed that a light oil film remained on the water as mentioned above.

Also, in the case of the sample of Reference Example, a light oil film remained as it was and no change was observed.

### EXAMPLE 2

<Production of Cylindrical Adsorbent Carbon>

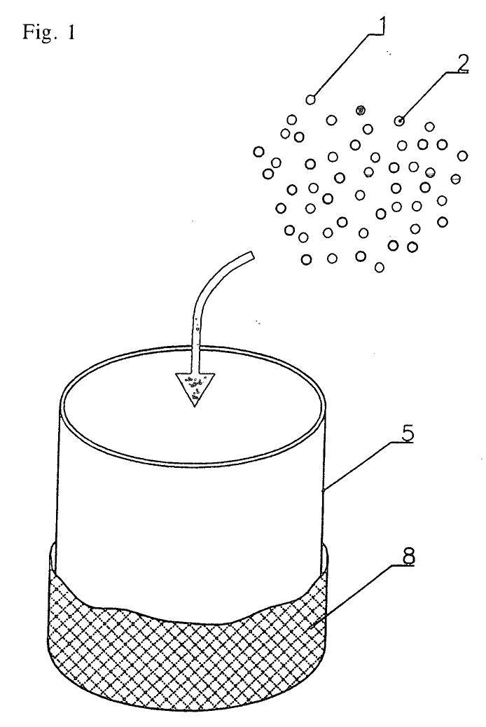

FIGS. 1 to 4 are views showing a step of processing an adsorbent carbon (powder) 1 according to the present invention into a cylindrical adsorbent carbon.

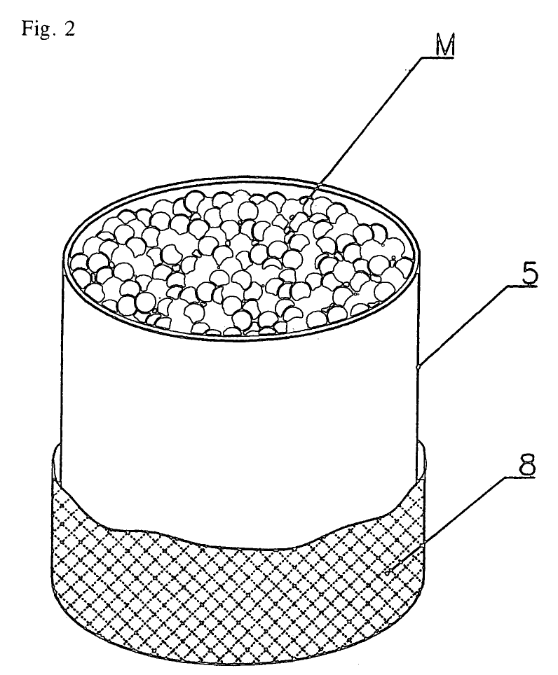

In this Example, as shown in FIGS. 1 and 2, first, an adsorbent carbon 1 and a powdery or granular hotmelt type resin (ethylene-vinyl acetate copolymer) 2 were filled in a mold 5 having a specified form to form a filler M.

Here, when filling the adsorbent carbon 1 and the powdery or granular ethylene-vinyl acetate copolymer 2 in the mold 5 having a specified form, the adsorbent carbon 1 and the ethylene-vinyl acetate copolymer 2 maybe individually laminated and filled. In this Example, a mixture of the adsorbent carbon 1 and the ethylene-vinyl acetate copolymer 2 (ratio by volume of adsorbent carbon/ethylene-vinyl acetate copolymer:8:2).

As the mold 5 having a specified form in this Example, a cylindrical one is used in this Example. However, no particular limitation is imposed on the form of the mold and any desired form is given as examples of the form.

Also, any material maybe used as the material constituting the mold 5 having a specified form without any particular limitation insofar as it is neither dissolved nor broken easily when it is treated by a steam S. Generally, natural materials such as wood and bamboo, metal materials such as stainless, heat-resistant polymer material or earthenware or ceramic materials may be preferably used.

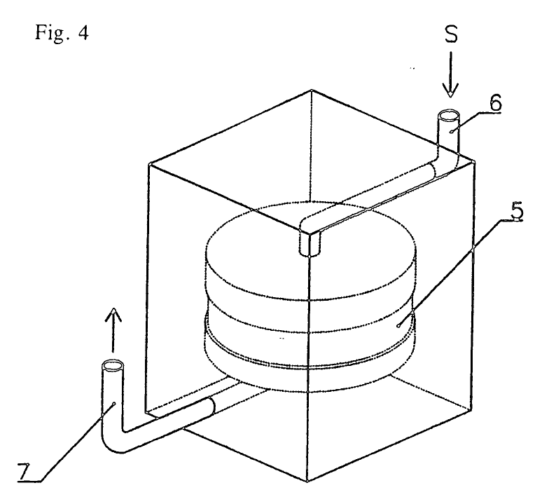

To state in more detail, as shown in FIG. 4, the cylindrical stainless mold (diameter: 2 cm, height: 3 cm) 5 has a structure provided with a steam introduction part 6 that supplies the steam S to the whole upper surface of the mold and a steam discharge part 7 that discharges the steam S to the whole bottom surface of the cylindrical mold, wherein the steam S can be suck from the steam discharge part 7.

Also, in this Example, the whole bottom surface of the stainless mold 5 is covered with a cloth body 8 so as to prevent the adsorbent carbon 1 and the powdery or granular ethylene-vinyl acetate copolymer 2 from running out before these components are filled.

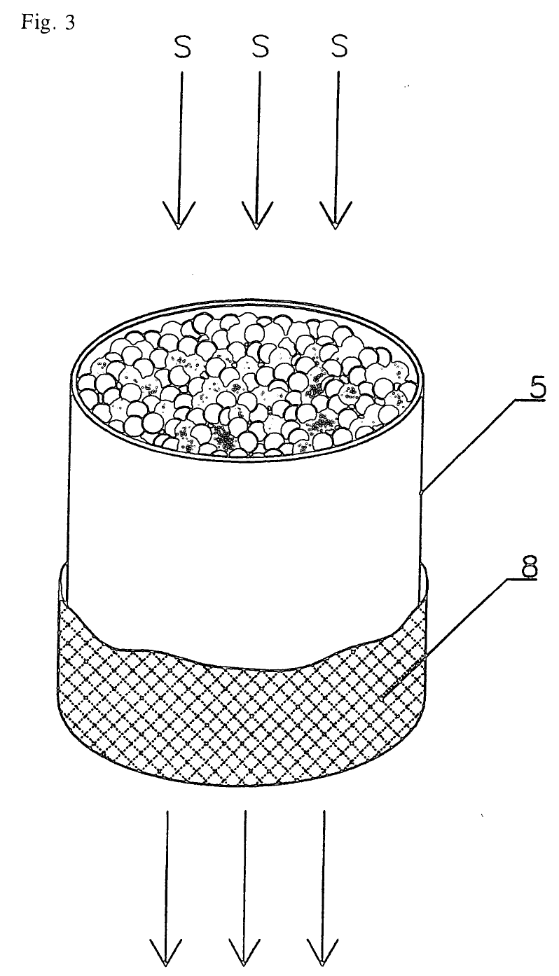

Then, in this Example, as shown in FIGS. 3 and 4, the steam S is made to pass through the filler M from the steam introduction part 6 to the steam discharge part 7 to thereby melt the above ethylene-vinyl acetate copolymer 2 with the heat of the steam S, thereby developing adhesiveness, whereby the above adsorbent carbon 12 can be made into a cylinder form.

In this case, in a process room, the steam introduction part 6 that has a pipe form and introduces the steam S generated in a steam generator (not shown) and the steam discharge part 7 that has a pipe form and discharges the introduced steam S are respectively disposed on the side surface of the process room, wherein the steam S can be suck from the steam discharge part 7.

Using the obtained cylindrical body, the same test as in Example 1 was made, to find that this cylindrical body was porous, was floated on the water and efficiently adsorbed a light oil film on the water and also that the recovery characteristics of the cylindrical body was superior after it was used.

### EXAMPLE 3

<Production of Water Quality Purifying Substrate>

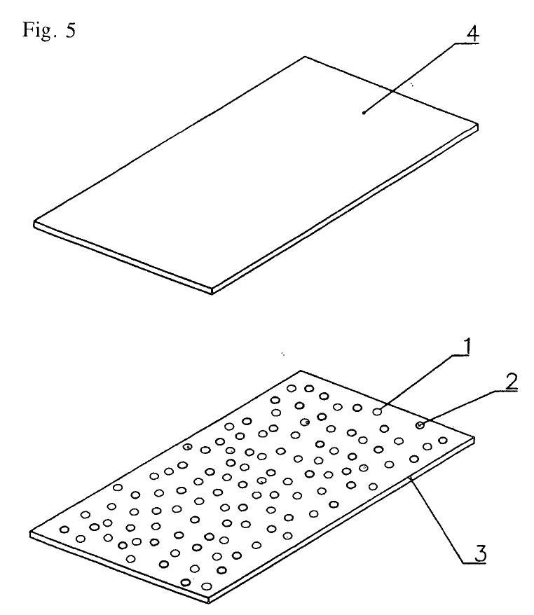

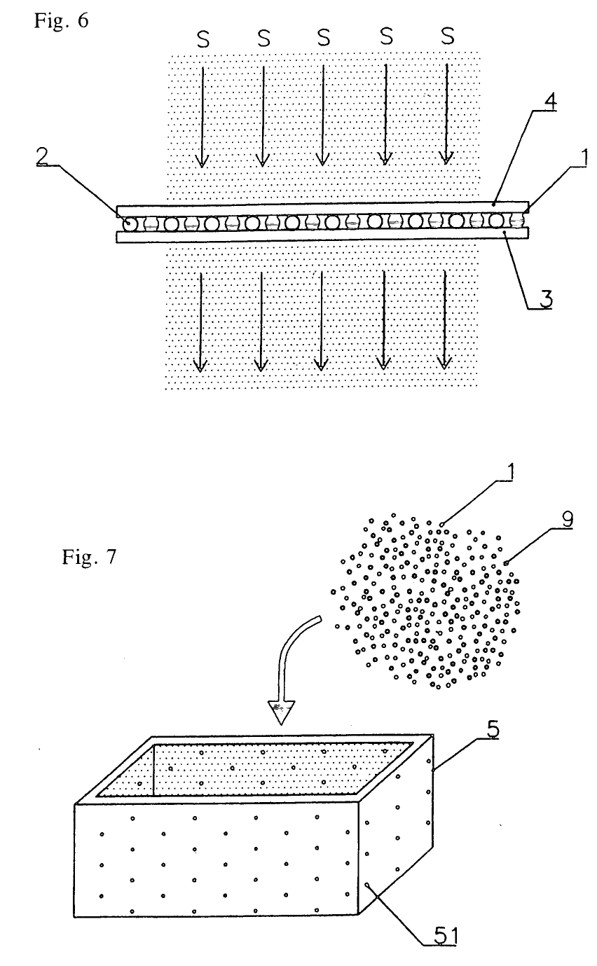

FIGS. 5 and 6 are views showing a process of processing the adsorbent carbon into a water quality purifying substrate having a sheet form.

In this Example, as shown in FIG. 5, first the adsorbent 1 and the powdery or granular ethylene-vinyl acetate copolymer 2 were sprayed and laminated on a cloth substrate 3 and further this laminate was covered with a cover material 4 made of cloth to form a laminate.

Here, when the mixture of the adsorbent carbon 1 and the powdery or granular ethylene-vinyl acetate copolymer 2 was sprayed and laminated on a cloth substrate 3, the adsorbent carbon 1 and the ethylene-vinyl acetate copolymer 2 may be individually sprayed and laminated, or a mixture of the adsorbent carbon 1 and the ethylene-vinyl acetate copolymer 2 may be sprayed and laminated. However, in this Example, a mixture of the adsorbent carbon 1 and the ethylene-vinyl acetate copolymer 2 is sprayed and laminated (ratio by volume of adsorbent carbon/ethylene-vinyl acetate copolymer:8:2).

Then, in this Example, as shown in FIG. 6, the steam S was made to pass through the laminate in the direction of the thickness of the laminate, for example, towards the substrate 3 from the cover material 4 to thereby melt the above ethylene-vinyl acetate copolymer 2 by the heat of the steam S, thereby developing adhesiveness to secure the above adsorbent carbon 1 between the above substrate 3 and the above cover material 4 to obtain a laminate (length: 90 cm, width: 35 cm).

The obtained laminate was cut down to the following size: length: 15 cm and width: 15 cm to obtain a laminate specimen.

The obtained laminate specimen was used to make the same test as in that of Example 1, to find that this laminate specimen was porous, was floated on the water and efficiently adsorbed a light oil film on the water and also that the recovery characteristics of the laminate specimen was superior after it was used.

### EXAMPLE 4

<Production of Water Quality Purifying Substrate>

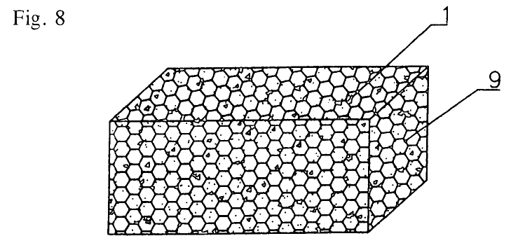

FIGS. 7 and 8 are views showing a process of processing the adsorbent carbon (powder) into a water quality purifying substrate in which the adsorbent carbon (powder) 1 is supported by a foam plastic support member.

In this Example, as shown in FIG. 7, first, foaming beads 9 prepared by impregnating polystyrene beads with about 5% of pentane and the adsorbent carbon 1 were filled in the mold 5 having a specified form to form a filler.

In this Example, one having a rectangular parallelopiped-form is used as the mold 5 having a specified form. However, a mold having a desired form may be used as the mold 5 without any particular limitation.

Also, any material may be used as the material constituting the mold 5 having a specified form without any particular limitation insofar as it is neither dissolved nor broken easily in the heating treatment (foaming treatment) which will be described later. In this example, as the mold 5, a mold made of aluminum is used, the mold having a rectangular parallelopiped form having a length of 2.5 cm, a width of 2.5 cm and a height of 2.5 cm and being provided with a large number of small holes 51 at its periphery. In succession, the filler obtained by filling the foaming beads 9 and the adsorbent carbon 1 was pre-foamed and then heated at a treating temperature of about 110 to 120° C. to obtain a water quality purifying substrate shown in FIG. 8.

When the resulting water quality purifying substrate was used to make the same test as that in Example 1, this water quality purifying substrate was found to be porous, floated on the water and adsorbed a light oil film on the water efficiently and it was also found that this water quality purifying substrate was significantly superior in the recovery characteristics after used.

1. An adsorbent carbon formed by carrying out heating and carbonizing treatment of a coconut mesocarp as its raw material.

2. The adsorbent carbon according to claim 1, wherein a fiber component has been removed from the coconut mesocarp.

3. The adsorbent carbon according to claim 1 or 2, wherein the temperature of the heating and carbonizing treatment is in a temperature range from 350 to 850° C.

4. The adsorbent carbon according to claim 1 or 2, wherein the adsorbent carbon is subjected to an activating treatment simultaneously with the heating and carbonizing treatment.

5. The adsorbent carbon according to claim 1 or 2, wherein the adsorbent carbon is subjected to an activating treatment after the heating and carbonizing treatment is finished.

6. The adsorbent carbon according to claim 4, wherein the activating treatment is carried out at a temperature range from 350 to 850° C.

7. The adsorbent carbon according to claim 1 or 2, wherein the adsorbent carbon is molded into a predetermined form.

8. The adsorbent carbon according to claim 7, wherein the molding of the adsorbent carbon into a predetermined form comprises filling a mold having the predetermined form with the adsorbent carbon and a powdery or granular hotmelt resin and passing steam through the filler to thereby melt the hotmelt resin with the heat of the steam, thereby causing the resin to adhere to the adsorbent carbon and form a body of the predetermined form comprising the adsorbent carbon and the resin.

9. A water purifier comprising the adsorbent carbon as claimed in claim 1 as its major component.

10. A water purifying bag produced by sealing the adsorbent carbon as claimed in claim 1 in a bag material.

11. A water purifying substrate produced by supporting the adsorbent carbon as claimed in claim 1 by a support member.

12. The water quality purifying substrate according to claim 11, the substrate being produced by mixing the adsorbent carbon with a binder and applying the mixture to the support member to thereby support the adsorbent carbon on the surface of the support member.

13. The water quality purifying substrate according to claim 11, wherein the support member is a fiber product, and the adsorbent carbon is supported in a fiber net made of the fiber product.

14. The water quality purifying substrate according to claim 11, wherein the support member is made of a film or sheet substrate and coating material having liquid-permeability, the adsorbent carbon and a powdery or granular hotmelt resin are laminated on the substrate to form a preliminary laminate and the preliminary laminate is covered with the coating material to form a final laminate, then steam is made to pass through the final laminate in a direction of the thickness of the final laminate to thereby melt the hotmelt resin by the heat of the steam, thereby causing the resin to adhere to the adsorbent carbon and support the adsorbent carbon between the substrate and the coating material.

15. The water quality purifying substrate according to claim 11, wherein the support member is a foam plastic and the adsorbent carbon is supported in the foam plastic.

16. The water quality purifying substrate according to claim 11, wherein the support member is soluble or decomposable in water.

17. A method of removing an oil film from water having the oil film floating thereon, comprising treating the water having the oil film floating thereon with the water purifier as claimed in claim 9, the water purifying bag as claimed in claim 10 or the water purifying substrate as claimed in any one of claims 11 to 16.

18. The adsorbent carbon according to claim 5, wherein the activating treatment is carried out at a temperature range from 350 to 850° C.

19. The absorbent carbon according to claim 7, wherein the predetermined from comprises a granular form, a pellet form, a tablet form or a pill form.
